(19) United States
(12) Patent Application Publication
(10) Pub. No.: US 2024/0004057 A1
(43) Pub. Date: Jan. 4, 2024

(54) METHOD AND SYSTEM FOR CORRELATING EVENTS

(71) Applicant: Orange, Issy-les-Moulineaux (FR)

(72) Inventor: Dinh Thuy Phan Huy, Châtillon Cedex (FR)

(21) Appl. No.: 18/255,272

(22) PCT Filed: Nov. 30, 2021
(86) PCT No.: PCT/FR2021/052146

§ 371 Date: May 31, 2023

(30) Foreign Application Priority Data
Dec. 1, 2020 (FR) FR2012461

(51) Int. Cl. G01S 13/75

(52) U.S. Cl. CPC G01S 13/75

(57) ABSTRACT

A method for correlating events is described. The method includes receiving a plurality of data streams, each of the streams having been emitted by an emitting source and including data representative of an event acquired by the source at the time of the emission and a marker representative of the backscattering of the data stream by a transmitting device. The method also includes determining a spatial and/or temporal correlation of the events from the markers.

### PRIOR ART

The present invention belongs to the general field of telecommunications. It relates, more particularly, to a method and a system for determining whether or not events which are produced at the time when sources emit data streams in a telecommunications network are correlated.

In the present document, an “event” is an event captured by a device referred to as a “source” and represented by a data stream transmitted by the source in a telecommunications network.

For example, when a source films a car which passes in front of a building and transmits live on a video stream network representing this scene, it can be considered that the video stream represents the event constituted by the passage of the car in front of the building at the time of shooting.

According to a second example, when a telephone transmits an audio stream on a mobile phone network, a sound element, for example the noise of an explosion, can be considered as representative of an event, namely that of the explosion, which would have occurred near the telephone at the time of the call.

More generally, in the context of this invention, when a source emits a data stream, it is hypothesised that this emission takes place during the course of an event defined in a spatio-temporal manner, wherein:
the spatial dimension is a location of the source of the data stream; and
the temporal dimension is a time of emission of the data stream by the source.

In other words, given a plurality of data streams emitted in a network, the invention aims to determine whether these streams are:
spatially correlated, in other words they have been emitted by one or more sources situated in nearby places;
temporally correlated, in other words they have been emitted by sources substantially simultaneously;
spatially and temporally correlated, or
neither spatially nor temporally correlated.

The invention has many applications. It can, for example, determine whether the emission of a video stream by a video-surveillance camera during a burglary (first event within the meaning of the invention) and the emission of a telephone call (second event within the meaning of the invention) by the telecommunication terminal of an individual are co-located (spatial correlation) and simultaneous (temporal correlation).

The document by R. B. Ghormade, S. Magar and B. Joshi, “Discovery of Neighbors in Wireless networks with Energy Efficient Approach” 2016 IEEE 6th International Conference on Advanced Computing (IACC), Bhimavaram, 2016, pp. 610-612” proposes mechanisms for determining whether two terminals are neighbours.

According to these mechanisms, the terminals emit a predefined beacon signal, and when one terminal detects this beacon signal emitted by another terminal, it deduces from it that this other terminal is in its vicinity.

A major disadvantage of these techniques is that they require the emission of a beacon signal and therefore an additional energy consumption by the terminals for this requirement.

### DISCLOSURE OF THE INVENTION

The object of the present invention is to overcome all or part of the disadvantages of the prior art, in particular those set out above.

To this effect, the invention relates to a method for correlating events, said method comprising the steps of:
receiving a plurality of data streams, each of said streams having been emitted by a source and comprising data representative of an event acquired by the source at the time of said emission, and a marker representative of the backscattering of said data stream by a transmitting device; and
determining a spatial and/or temporal correlation of said events from said markers.

In conjunction, the invention relates to a system for correlating events comprising:
at least one receiving module configured for receiving a plurality of data streams, each of said streams having been emitted by a source and comprising data representative of an event acquired by the source at the time of this emission, and a marker representative of the backscattering of said data stream by a transmitting device; and
a correlation module configured for determining a spatial and/or temporal correlation of said events from said markers.

Thus, and in a general manner, the invention discloses determining whether data streams have been emitted substantially simultaneously and/or by neighbouring sources, by analysing markers introduced into these data streams by backscattering.

In contrast to the above-mentioned techniques from the prior art, the emitting sources of a data streams do not need to emit a beacon signal in order to signal themselves to their neighbours. They do not do any processing and therefore do not consume any resource for this purpose.

More generally and very advantageously, conforming with the mechanisms for communication by ambient backscattering, no radiofrequency signal is emitted to mark the data streams emitted by the sources, the transmitting device exploiting the signal emitted by a source in order to communicate the marker to the receiving module.

The energy required for implementing the invention is therefore substantially that required for analysing the markers in order to determine the spatial and/or temporal correlation of the events.

In a particular embodiment:
the marker representative of the backscattering of each of said data streams comprises an identifier of the transmitting device having backscattered said data streams; and
said correlation is a spatial correlation.

According to this embodiment, it is considered that events are spatially correlated if signals emitted by the sources during these events and backscattered, comprise identical markers.

This embodiment of the invention is advantageous because it can be implemented using transmitter devices which conform with the prior art, since these transmitting devices mark the backscattered signal with their individual identifiers.

According to a second aspect, the invention relates to a method implemented by a transmitting device configured for backscattering an ambient signal emitted by a source (SOi), said ambient signal carrying a data stream emitted by the source, said method comprising a step of marking said stream with a marker representative of the location of said transmitting device or of a time of backscattering of said data streams by said transmitting device, wherein:
said location is obtained from a geolocation module of the transmitting device; and
said time of backscattering is obtained from a clock of the transmitting device.

In conjunction, the invention relates to a transmitting device comprising a geolocation module of this device and a clock, said device being configured for backscattering an ambient signal emitted by a source, said ambient signal carrying a data stream emitted by the source, said device comprising a module for marking said stream with a marker representative of the location of said transmitting device or of a time of backscattering of said data stream by said transmitting device, wherein:
said location is obtained from said geolocation module; and
said time of backscattering is obtained from said clock.

The invention thus discloses a novel type of device capable of marking a stream with a piece of spatial and/or temporal information making it possible to date and/or locate the emission of this stream, with very low energy consumption.

In a particular embodiment:
the marker representative of the backscattering of each of said data streams comprises a piece of temporal information representative of the time of backscattering of said data stream; and:
said correlation is a temporal correlation.

In accordance with this embodiment, it is considered that events are temporally correlated if the signals emitted by the sources during these events and backscattered, comprise markers representing substantially simultaneous times of backscattering, for example spaced apart by a duration less than a threshold value.

In a particular embodiment:
the marker representative of the backscattering of each of said data streams comprises a piece of spatial information representative of the location of the transmitting device having backscattered said data stream; and:
said correlation is a spatial correlation.

In accordance with this embodiment, it is considered that events are spatially correlated if the signals emitted by the sources during these events and backscattered, comprise markers representing neighbouring locations, for example separated by a distance less than a threshold value.

In a particular embodiment, the system for correlating events is incorporated in a telecommunications device, for example a base station or a terminal.

In this embodiment of the invention, the sources can be terminals and the signals emitted by these terminals can be signals emitted in the uplink direction and comprising data intended for the base station.

In an embodiment of the invention, the system is distributed over a plurality of devices. This system comprises:
at least one telecommunications device comprising said at least one receiving module; and
a correlation device, separate from said at least one receiving device, and comprising said correlation module.

The telecommunication devices can be base stations receiving signals emitted by the terminals, at least some of these signals being backscattered by transmitting devices. The correlation device which analyses these markers in order to detect any correlated events can be centralised in the network.

According to a third aspect, the invention relates to a computer program comprising instructions for implementing the method for correlating events according to the invention, when said program is executed by a computer.

This program can use any programming language, and be in the form of source code, object code, or code that is intermediate between source code and object code, such as in a partially compiled form, or in any other desirable form.

According to a fourth aspect, the invention relates to a computer program comprising instructions for implementing the marking method according to invention, when said program is executed by a computer.

These programs can use any programming language, and be in the form of source code, object code, or code that is intermediate between source code and object code, such as in a partially compiled form, or in any other desirable form.

According to a third aspect, the invention relates to a computer-readable data storage or recording medium, on which a computer program according to the invention is recorded.

The data storage or recording medium can be any entity or device capable of storing the program. For example, the medium may comprise storage means, such as a ROM, for example a CD ROM or a microelectronic circuit ROM, or even a magnetic recording means, for example a hard drive.

On the other hand, the data storage or recording medium can be a transmissible medium such as an optical or electrical signal, which can be routed via an electrical or optical cable, by radio or by other means. In particular, the program according to the invention can be downloaded on an Internet-type network.

Alternatively, the data storage or recording medium can be an integrated circuit in which the program is incorporated, the circuit being suitable for executing or for being used in the execution of the method in question.

### BRIEF DESCRIPTION OF THE FIGURES

Other features and advantages of the present invention will become apparent from the description given below, with reference to the appended drawings which illustrate an exemplary embodiment that is in no way limiting. In the figures:

FIG. 1 schematically shows, in its environment, a particular embodiment of a system for correlating events according to a first embodiment of the invention;

FIG. 2 schematically shows an example hardware architecture of a transmitting device, in accordance with a particular embodiment of the invention;

FIG. 3 schematically shows an example hardware architecture of a correlation device, in accordance with a particular embodiment of the invention;

FIG. 4 shows, in the form of a flow diagram, the main steps of a method for marking and a method for correlating events, in accordance with a particular exemplary implementation of the invention;

FIG. 5 shows a system for correlating events according to another embodiment of the invention;

FIG. 6 shows a system for correlating events according to another embodiment of the invention;

FIG. 7 shows a system for correlating events according to another embodiment of the invention;

FIG. 8 shows a system for correlating events according to another embodiment of the invention; and

FIG. 9 shows a system for correlating events according to another embodiment of the invention.

### DESCRIPTION OF THE EMBODIMENTS

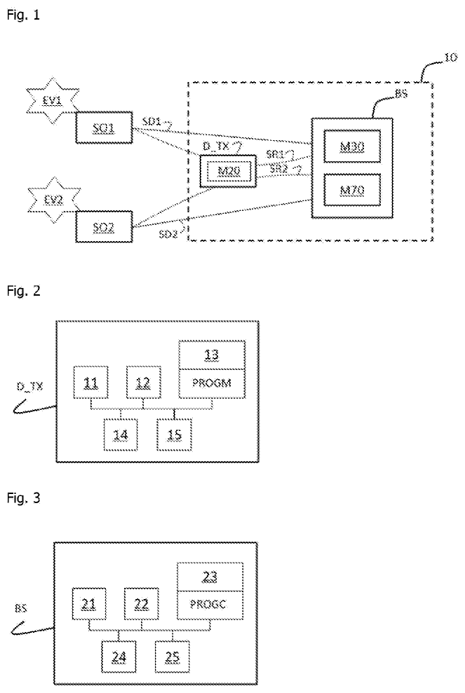

FIG. 1 schematically shows, in its environment, a particular embodiment of a system 10 for correlating events according to the invention.

In the example of FIG. 1, the environment of the correlation system 10 comprises two sources SO1, SO2.

Each emitting source SO1, SO2 is configured to emit, according to an emission frequency F_E included in a given frequency band referred to as the “emission band”, a radio signal referred to as the “ambient signal”. The emission of the ambient signal is carried out, for example, continuously for repetitively.

The term “radio signal” refers here to an electromagnetic wave propagating by wireless means, the frequencies of which are included in the conventional spectrum for radio waves (several hertz to several hundred gigahertz).

By way of non-limiting example, an ambient signal is a 4G mobile telephone signal in the emission band [811 MHz, 821 MHz]. The source SO1 or SO2 can consist of a telecommunications terminal, for example a cell phone.

It is however useful to specify that the invention remains applicable to other types of radio signals, such as a mobile telephone signal other than 4G (for example 2G, 3G, 5G), a Wi-Fi signal, a WiMax signal, a DVB-T signal, etc. In general, no limitation is attached to the ambient radio signal which can be considered within the context of the present invention. Consequently, it is useful to note that the number of antennas equipping a source SO1/SO2 does not constitute a limiting factor of the invention.

In the example of FIG. 1, the system 10 for correlating events comprises a telecommunications device consisting of a base station BS. This telecommunications device comprises a receiving module M30 configured for communicating with a transmitting device D_TX by ambient backscattering of an ambient signal emitted by the source SO1 or SO2. It should be noted that, in accordance with the invention, the telecommunications device BS is separate from the sources SO1, SO2.

In a manner known per se, the communication by ambient backscattering consists of the use of the ambient signal, by the transmitting device D_TX, for sending data to a receiving module M30. More particularly, the transmitting device D_TX (respectively, the receiving module M30) is configured to carry out, on the basis of the ambient signal (respectively, on the basis of the backscattered signal), processing aimed at backscattering said ambient signal (respectively, aimed at decoding said backscattered signal), by implementing a backscattering method (respectively, a decoding method).

For this purpose, the transmitting device D_TX (respectively, the receiving module M30) comprises, for example, one or more processors and storage means (magnetic hard disc, electronic memory, optical disc, etc.) in which data and a computer program are stored, in the form of a set of program code instructions to be executed in order to implement the backscattering method (respectively, the decoding method).

Alternatively or in addition, the transmitting device D_TX (respectively the receiving module M30) also comprises one or more programmable logic circuits, of type FPGA, PLD, etc., and/or specialised integrated circuits (ASIC), and/or a set of discrete electronic components, etc., suitable for implementing the backscattering method (respectively, the decoding method).

In other words, the transmitting device D_TX (respectively, the receiving module M30) comprises a set of means configured as software (specific computer program) and/or hardware (FPGA, PLD, ASIC, etc.) for implementing the backscattering method (respectively, the decoding method).

The specific aspects concerning the emitting of data by backscattering to the receiving module M30, as well as those concerning the decoding techniques implemented by the latter, are known to a person skilled in the art and are outside the scope of the present invention. Consequently, they are not detailed further here.

In the present embodiment, the transmitting device D_TX is equipped with an antenna (not shown in the figures) configured, in known manner per se, to receive the ambient signal but also to backscatter it to the telecommunications device BS. It is useful to note that no limitation is attached to the number of antennas which can equip the transmitting device D_TX.

In practice, the transmitting device D_TX is associated with a frequency band, referred to as the “band of influence”, which corresponds to the frequency band in which the antenna is able to receive/backscatter signals. When said band of influence is included in the emission band associated with the source S01, S02 of the ambient signal, it is qualified as the “working band”. The term “working band” refers here to the fact that the transmitting device D_TX is compatible with the source SO1 or SO2 of the ambient signal, namely therefore that the backscattering can be carried out for any frequency included in said working band.

Nothing, however, excludes considering a band of influence which is not included in the emission band. It is nevertheless implicit in order that the transmitting device D_TX is able to backscatter the ambient signal, said band of influence and said emission band must have a non-empty intersection, the working band corresponding therefore to this intersection.

The transmitting device D_TX is likewise associated with operating states, namely at least one state referred to as “backscattering” (the transmitting device backscatters the ambient signal) as well as a contrary state referred to as “non-backscattering»(the transmitting device does not backscatter the ambient signal, or, put another way, is “transparent” to the ambient signal). These states corresponded to configurations in which said antenna is connected to distinct impedances. This typically involves a positive, or even zero, impedance for a backscattering state and, by contrast, a theoretically infinite impedance for the non-backscattering state.

For the rest of the description, it is considered, in a non-limiting manner, that the transmitting device D_TX is associated with a single backscattering state as well as with a single non-backscattering state. Nevertheless, the invention remains applicable in the case of a transmitting device D_TX associated with a plurality of backscattering states, these states being distinct from one another in that they are implemented using respective impedances which are distinct from one another (the non-backscattering state remains unique). The developments which follow can be generalised, without difficulty, by a person skilled in the art, to the case where a plurality of backscattering states is considered.

In an embodiment, the transmitting device D_TX comprises a geolocation module configured for obtaining a current location LOC_i of this device.

In an embodiment, the transmitting device D_TX comprises a clock configured for obtaining a current date and time.

In the present embodiment, the telecommunications device BS is equipped with a receiving antenna (not shown in the figures) configured for receiving signals in said working band.

It is however useful to note that no limitation is attached to the number of antennas that can equip the telecommunications device BS.

The receiving module 30 of the telecommunications device BS receives non-backscattered signals as emitted by the source SO1, SO2 and signals emitted by the sources SO1, SO2 and backscattered by the transmitting device D_TX.

The following notation is adopted in the present description:
SDi designates a signal emitted by the source SOi received by the receiving module M30 but without backscattering. These signals are represented by solid lines; and
SRi designates a signal emitted by the source SD, received by the receiving module M30 and backscattered by the transmission device D_TX. These signals are represented by dotted lines.

In the rest of the description, and by way of simplification, the same notation SDi will be used to designate the signal SDi emitted by the source SOi and the data streams carried by the signal SDi.

Similarly, the same notation SRi is used to designate the signal backscattered by the transmitting device D_TX and the data streams carried by this signal.

In the embodiment described here, the transmitting device D_TX comprises a module M20 for marking the backscattered data streams SRi with a marker TAGi representative of this backscattering.

In the embodiment of FIG. 1, the marker TAGi comprises at least one element from:
(i) an identifier of the transmitting device D_TX;
(ii) a location of the transmitting device D_TX obtained from the geolocation module;
(iii) a time of backscattering of the signal SRi by the transmitting device D_TX obtained from the above-mentioned clock.

As mentioned above, the receiving module M30 is configured to decode the signal backscattered by the transmitting device D_TX. For this purpose, it is known that the decoding of the backscattered signal can only be implemented if the electromagnetic power variation, referred to as “power deviation” E_P, received by the receiving module M30 according to whether the transmitting device D_TX is in a backscattering or non-backscattering state, is, in absolute value, greater than a predetermined threshold value, referred to as the “power threshold” S_P. In other words, said power threshold S_P determines the value of the power deviation E_P from which the receiving module M30 is able to decode a signal emitted by a source SO1, SO2 and backscattered by the transmitting device D_TX.

Said power threshold S_P is, for example, defined from a signal-to-noise ratio “SNR” on the receiver device side D_RX or even, according to an alternative, from a signal to interference plus noise ratio “SINK” on the receiver device side D_RX. However, there is nothing to exclude considering yet other metrics for defining said power threshold, such as a bit error rate “BER” , for example. With regard to these aspects, a person skilled in the art could refer to the document: “Real-Time Ambient Backscatter Demonstration”, K. Rachedi, D. T. Phan-Huy, N. Selmene, A. Ourir, M. Gautier, A. Gati, A. Galindo-Serrano, R. Fara, J. De Rosny, IEEE INFOCOM 2019 Posters and Demos, 1^{st} May 2019, Paris, France.

In accordance with the invention, it is considered that the signal emitted by a source SO1, SO2 is emitted during an event defined in a spatio-temporal manner, wherein:
the spatial dimension is a location of the source of the data streams; and
the temporal dimension is a time of emission of the data streams by the source.

In the embodiment of FIG. 1, the telecommunications device BS, consisting in this example of a base station, comprises a correlation module M70 configured for determining, from markers TAGi, TAGj included in the backscattered data streams, whether or not there is a spatial and/or temporal correlation between the events EVi, EVj during which these stream have been emitted by their respective sources.

In the embodiment described here, if the marker TAGi of the stream SRi backscattered by a transmitting device D_TX comprises the identifier of this transmitting device D_TX, the correlation module M70 determines that the events EVi, EVj are spatially correlated if signals emitted by the sources during these events and backscattered, comprise identical markers TAGi, TAGj.

In the embodiment described here, if the marker TAGi of the stream SRi backscattered by a transmitting device D_TX comprises a time of backscattering of the signal SRi by the transmitting device D_TX, the correlation module M70 determines that the events EVi, EVj are temporally correlated if the signals emitted by the sources during these events and backscattered, comprise markers TAGi, TAGj representing substantially simultaneous times of backscattering, for example separated by a duration less than a threshold value.

In the embodiment described here, if the marker TAGi of the stream SRi backscattered by a transmitting device D_TX comprises the identifier of this transmitting device D_TX, the correlation module M70 determines that the events EVi, EVj are spatially correlated if signals emitted by the sources during these events and backscattered, comprise markers TAGi, TAGj representing neighbouring locations, for example separated by a distance less than a threshold value.

In the embodiment described here, if the marker TAGi of the stream SRi backscattered by a transmitting device D_TX comprises a combination of the time of backscattering of the signal SRi by the transmitting device D_TX with the identifier of the transmitting device D_TX, the correlation module M70 determines that the events EVi, EVj are spatially and temporally correlated if the signals emitted by the sources during these events and backscattered, comprise markers TAGi, TAGj representing the same identifier and substantially simultaneous times of backscattering, for example separated by a duration less than a threshold value.

In the embodiment described here, if the marker TAGi of the stream SRi backscattered by a transmitting device D_TX comprises a combination of the time of backscattering of the signal SRi by the transmitting device D_TX with the location of the transmitting device D_TX, the correlation module M70 determines that the events EVi, EVj are spatially and temporally correlated if the signals emitted by the sources during these events and backscattered, comprise markers TAGi, TAGj representing neighbouring locations and substantially simultaneous times of backscattering.

FIG. 2 schematically shows an example of hardware architecture of a transmitting device D_TX in accordance with a particular embodiment of the invention.

In the embodiment described here, the transmitting device D_TX has the hardware architecture of a computer. It comprises, in particular, a processor 11, a RAM memory 12, a ROM memory 13 and a non-volatile memory 14.

The ROM memory 13 constitutes a recording medium in accordance with the invention, which can be read by the processor 11 and on which is recorded a computer program PROGM in accordance with the invention, comprising instructions for the execution of the steps of the marking method according to the invention. The program PROGM defines functional modules of the transmitting device D_TX, which rely on or control the hardware elements 12 to 14 of the transmitting device D_TX cited above and, in particular, a module for marking a data stream with a marker TAGi as described above.

FIG. 3 schematically shows an example of hardware architecture of a telecommunications device BS in accordance with a particular embodiment of the invention.

In the embodiment described here, the telecommunications device BS has the hardware architecture of a computer. It comprises, in particular, a processor 21, a RAM memory 22, a ROM memory 23 and a non-volatile memory 24.

The ROM memory 23 constitutes a recording medium in accordance with the invention, that can be read by the processor 21 and on which is recorded a computer program PROGC in accordance with the invention, comprising instructions for the execution of the steps of the method for correlating events according to the invention. The program PROGC defines functional modules of the telecommunications device BS, which rely on or control the hardware elements 22 to 24 of the telecommunications device BS cited above, and in particular:
a receiving module M30 configured for receiving a variety of data streams, each of these streams having been emitted by an emitting source during an event and comprising a marker representative of the backscattering of this stream by a transmitting device; and
a correlation module M70 configured for determining a spatial and/or temporal correlation of these events from said markers.

FIG. 4 shows, in the form of a flow diagram, a method for marking and a method for correlating events according to particular embodiments of the invention.

As illustrated by FIG. 4, a source SOi emits a data stream SDi during a step E10.

During a step E20, a transmitting device D_TX backscatters this stream while marking the backscattered stream Sri with a marker TAGi representative of the backscattering of this stream by this transmitting device.

In the embodiment described here, the marker TAGi comprises at least one element from:
(i) an identifier of the transmitting device D_TX;
(ii) a location of the transmitting device D_TX;
(iii) a time of backscattering of the signal SRi by the transmitting device D_TX.

A receiving module M30 is configured for receiving, during a step E30, the stream SRi backscattered by the transmitting device D_TX.

In the embodiment described here, during a step E40, the receiving module M30 records, in a database BD, a record comprising the marker TAGi and at least one piece of information from:
the identifier of the source SOi of the data stream; or
the data of the data stream SRi.

The database BD comprises such records for various backscattered data streams SRi, SRj.

During a step E50, a correlation module M70 obtains the markers TAGi, TAGj corresponding to various backscattered data streams SRi, SRj.

During a step E60, the correlation module M70 compares the markers TAGi, TAGj in order to determine whether or not there is a spatial correlation and/or a temporal correlation between the events EVi, EVj during which these streams have been emitted by their respective sources.

In the embodiment described here:
if the marker TAGi, TAGj comprises the identifier of the transmitting device D_TX which has backscattered the stream, the correlation module M70 determines, during a step E70, that the events EVi, EVj are spatially correlated if the markers TAGi, TAGj are identical;
if the marker TAGi, TAGj comprises a time of backscattering of the stream, the correlation module M70 determines during this step E70, that the events EVi, EVj are temporally correlated if these markers TAGi, TAGj represent substantially simultaneous times of backscattering, for example separated by a duration less than a threshold value;
if the marker TAGi, TAGj comprises a location of the transmitting device D_TX, the correlation module M70 determines during this step E70, that the events EVi, EVj are temporally correlated if these markers TAGi, TAGj represent neighbouring locations, for example separated by of a distance less than a threshold value;
if the marker TAGi, TAGj comprises a combination of the time of backscattering of the signal SRi by a transmitting device D_TX with the identifier of this transmitting device D_TX, the correlation module M70 determines during this step E70 that the events EVi, EVj are spatially and temporally correlated if these markers TAGi, TAGj represent the same identifier and substantially simultaneous times of backscattering;
if the marker TAGi, TAGj comprises a combination of the time of backscattering of the signal by a transmitting device D_TX with the location of this transmitting device D_TX, the correlation module M70 determines during this step E70 that the events EVi, EVj are spatially and temporally correlated if these markers TAGi, TAGj represent neighbouring locations and substantially simultaneous times of backscattering.

In the contrary case, the correlation module M70 determines during a step E80 that the events EVi, EVj are not correlated either spatially or temporally.

In the example of FIG. 1 described above, the correlation system 10 comprises a telecommunications device consisting of a base station BS and a transmitting device D_TX.

As mentioned above, the invention can be implemented with transmitting devices D_TX configured for marking the backscattered signal with their individual identifier.

In particular, the invention can be implemented with transmitting devices D_TX in accordance with the prior art and configured for marking the backscattered signal with their individual identifier.

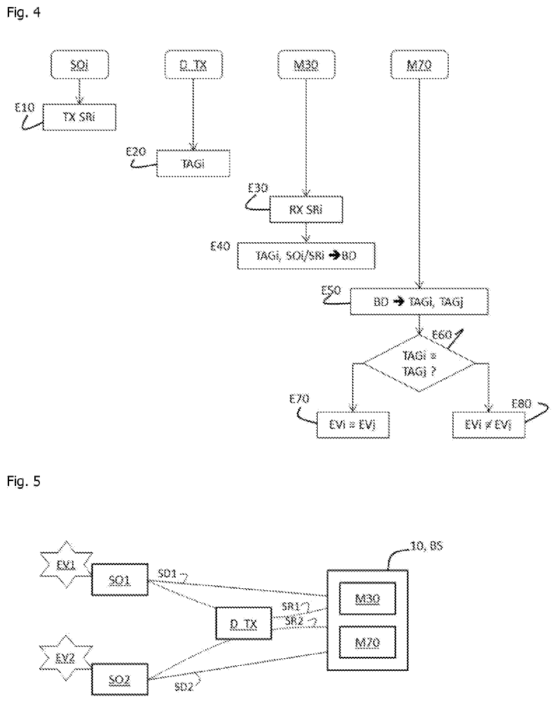

In this embodiment, and as shown for example in FIG. 5, the correlation system can be incorporated in a telecommunications device, for example a base station BS.

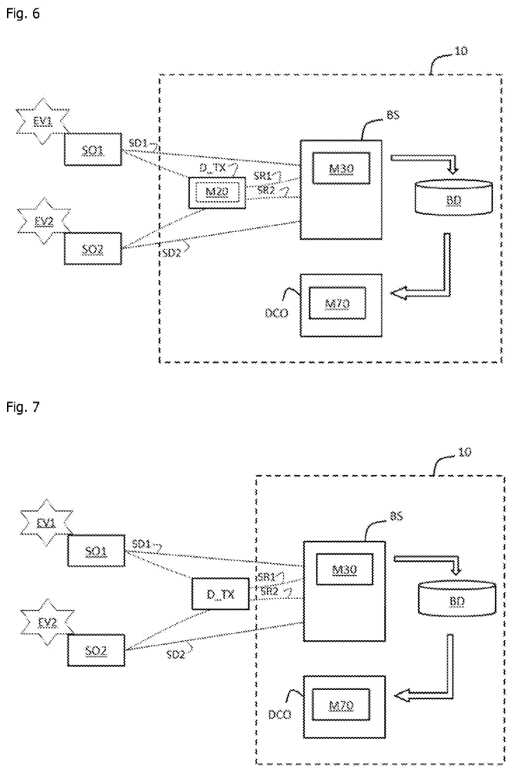

The correlation system of FIG. 6 differs from that of FIG. 1 in that it comprises:
at least one telecommunications device BS (for example a base station) comprising the receiving module M30; and
a correlation device DCO, separate from the receiving device, and comprising the correlation module M70.

Hence, in this embodiment, the database BD can be supplied by a plurality of base stations, the records of the database BD being analysed by the same correlation device DCO in order to determine whether or not the events are correlated.

In this embodiment, in particular, the telecommunication devices (base stations) can add, in the record of the database, the time at which they receive a backscattered data stream.

Hence, if the transmitting device D_TX marks the backscattered signal with its identifier or with its location information, but without marking the stream with a piece of temporal information, the correlation device can use the time of reception of the backscattered stream by the base station in order to correlate the events temporally, if the base stations are synchronised with one another.

The correlation system of FIG. 7 differs from that of FIG. 6 in that it uses transmitting devices D_TX according to the prior art and configured to mark the backscattered signal with their individual identifier.

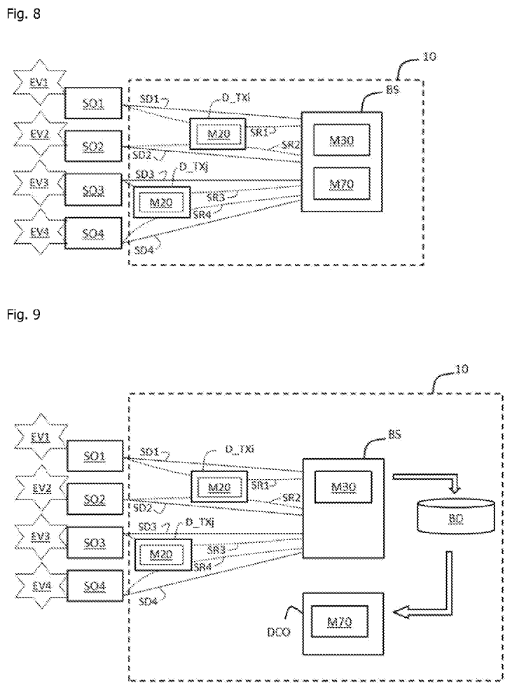

The correlation system of FIG. 8 is identical to that of FIG. 1 but it comprises a plurality of transmitting devices D_TXi, D_TXj (only two being shown in order not to overcrowd the figure).

The telecommunications device BS (for example a base station) receives backscattered signals from transmitting devices D_TXi, D_TXj, for example the signals SR1, SR2 from D_TXi and the signals SR3, SR4 from D_TXj.

If the transmitting devices D_TXi, D_TXj mark the streams that they backscatter with a piece of spatial information representative of their location, the telecommunications device can determine whether the events during which these streams have been broadcast by their sources are spatially correlated.

If the transmitting devices D_TXi, D_TXj mark the streams that they backscatter with a piece of temporal information representative of the time at which they have backscattered the stream, the telecommunications device can determine whether the events during which these streams have been broadcast by their sources are temporally correlated. For this, it is necessary that the transmitting devices D_TXi, D_TXj are synchronised with one another.

The system of FIG. 9 is identical to that of FIG. 8, except that the receiving M30 and correlation M70 modules are incorporated in two distinct devices.

As in the case of FIG. 6, the database BD can be supplied by a plurality of base stations, the records of the database BD being analysed by the same correlation device DCO in order to determine whether or not the events are correlated.

1. A method for correlating events, the method comprising:
receiving a plurality of data streams, each of said streams having been emitted by a source and comprising:
data representative of an event acquired by said source at the time of said emission, and
a marker representative of the backscattering of said data stream by a transmitting device; and
determining a spatial and/or temporal correlation of said events from said markers.

2. The method of claim 1, wherein:
the marker representative of the backscattering of each of said data streams comprises an identifier of the transmitting device having backscattered said data streams; and
said correlation is a spatial correlation.

3. The method for of claim 1, wherein:
the marker representative of the backscattering of each of said data streams comprises a piece of temporal information representative of the time of backscattering of said data streams; and
said correlation is a temporal correlation.

4. The method f of claim 1, wherein:
the marker representative of the backscattering of each of said data streams comprises a piece of spatial information representative of the location of the transmitting device having backscattered said data streams; and
said correlation is a spatial correlation.

5. A system for correlating events, the system ( comprising:
at least one receiving module configured for receiving a plurality of data streams, each of said streams having been emitted by a source and comprising:
data representative of an event acquired by said source at the time of said emission, and
a marker representative of the backscattering of said data stream by a transmitting device; and
a correlation module configured for determining a spatial and/or temporal correlation of said events from said markers.

6. The system of claim 5, wherein said system is incorporated in a telecommunications device.

7. The system of claim 5, wherein the system comprises:
at least one telecommunications device comprising said at least one receiving module; and
a correlation device, separate from said at least one telecommunications device, and comprising said correlation module.

8. The system of claim said telecommunications device is a base station.

9. (canceled)

10. A non-transitory, computer readable medium having stored thereon instructions which, when executed by a processor, cause the processor to implement the method of claim 1.

11. A marking method implemented by a transmitting device configured for backscattering an ambient signal emitted by a source, said ambient signal carrying a data stream emitted by said source, said method comprising a step of marking said stream with a marker representative of a location of said transmitting device or of a time of backscattering of said data stream by said transmitting device, wherein:
said location is obtained from a geolocation module of the transmitting device; and
said time of backscattering is obtained from a clock of the transmitting device.

12. A transmitting device comprising a geolocation module of said device and a clock, said device being configured for backscattering an ambient signal emitted by a source, said ambient signal carrying a data stream emitted by said source, said device comprising a module for marking said stream with a marker representative of a location of said transmitting device or of a time of backscattering of said data stream by said transmitting device, wherein:
said location is obtained from said geolocation module; and
said time of backscattering is obtained from said clock.

13. (canceled)

14. A non-transitory, computer readable medium having stored thereon instructions which, when executed by a processor, cause the processor to implement the method of claim 11.

15. The system of claim 5, wherein said transmitting device comprises a geolocation module of said transmitting device and a clock, said transmitting device being configured for backscattering an ambient signal emitted by a source, said ambient signal carrying a data streamemitted by said source, said transmitting device comprising a module for marking said stream with a marker representative of a location of said transmitting device of a time of backscattering of said data stream by said transmitting device, wherein said location is obtained from said geolocation module, and wherein said time of backscattering is obtained from said clock.
